(19) United States
(12) Patent Application Publication
(10) Pub. No.: US 2008/0240332 A1
(43) Pub. Date: Oct. 2, 2008

(54) Condecast EV 2 inertial guided themonuclear perfumagnetron fusion reactor

(75) Inventor: Conrado G. Castro, Gardena, CA (US)

Correspondence Address: CONRADO G. CASTRO, 3514 WEST 157th ST., GARDENA, CA, 90249, US

(73) Assignee: FAMILY

(21) Appl. No.: 11/731,031

(22) Filed: Mar. 29, 2007

(51) Int. Cl. G21B 1/00

(52) U.S. Cl. 376/317

(57) ABSTRACT

Problem-Solution

The prior art propelling motor vehicles uses the internal combustion engine blamed for the damage to the environment and global warming.

The solution lies in my invention which replaces the internal combustion engine but still using hydrogen as choice fuel and all fossil fuels.

The technological invention is called CONDECAST EV-2 named after me, an inertial guided thermonuclear magnetic perfumagnetron fusion reactor. Hydrogen with an energy content of 2 gallon is equal to 2600 gallons and fossils are fed in the form of vapor fumes and burned in the reactor simulating lightning arc and thunder in the skies. Using hydrogen you get 26,000 miles per gallon.

For fossils—300 to 500 miles per gallon, depending on how fast you drive.

Flow chart for schematic diagram of inertial guided thermonuclear magnetic perfumagnetron fusion reactor

Components for EV2 Condecast fusion reactor

Complete Built-up motor vehicle without internal combustion engine brand new or old

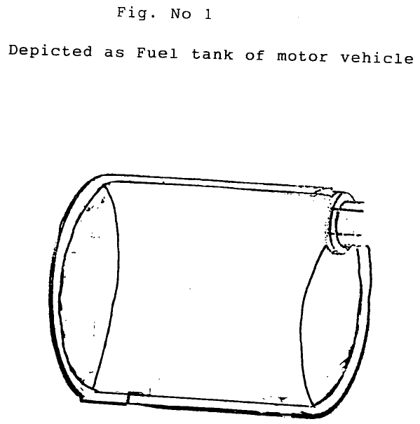

FIG. 1—fuel tank for fossil fuel or hydrogen movable fore and apt for oscillation and diffusion or atom elements of fuel for conversion to vapor fumes from connecting pipe from tank to reservoir.

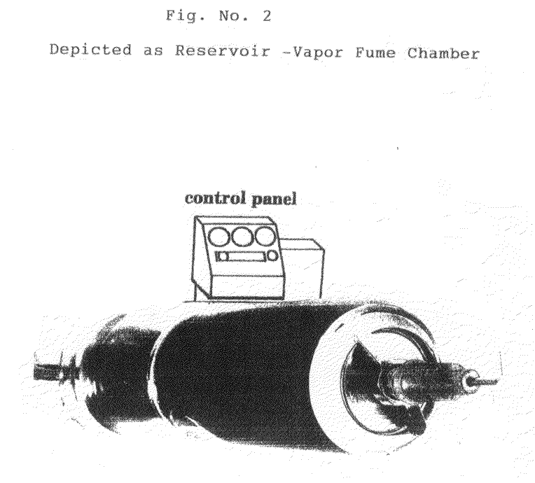

FIG. 2—reservoir for built-up pressure of vapor fumes oscillated to be released via connection pipe or hose to the reactor in minute puffs or whiffs to be detonated or ignited in a lightning and thunder nuclear reaction,

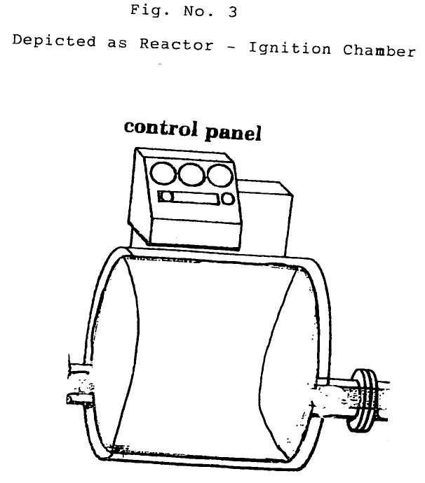

FIG. 3—fusion reactor for fossil fuel or hydrogen. This is the heart of the system that make electric vehicles possible non-plugged zero emission and range limitless. The reactor is connected with the reservoir via pipe or hose for vapor fumes entry which detonates or ignites the fumes in the magnetic field of the reactor in quantities of puffs and whiffs by the electric field action of the glow plug and magnetic flux converting the vapor fumes into very high power and high density to be stored in the battery pack and energize electric motor through positive and negative electrodes wirings.

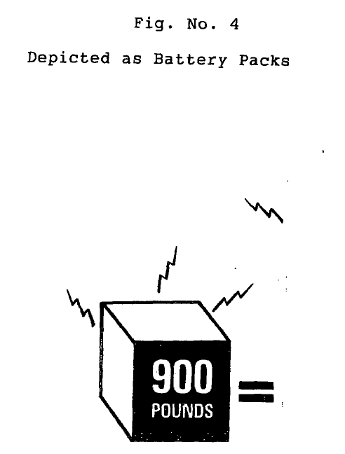

FIG. 4—the battery pack and one 12-volt battery for ignition and serve accessories. The battery pack is the storage for high power and density of electricity to energize the electric motor traction.

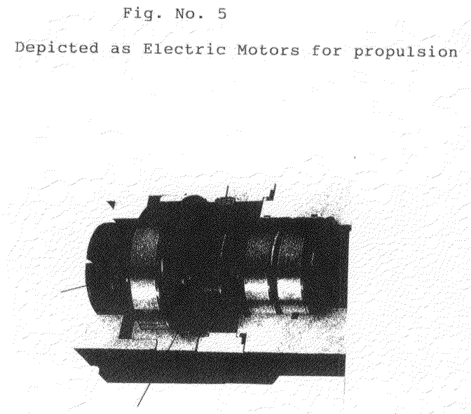

FIG. 5—the electric motor energized by the battery pack propels the wheels of the electric vehicle.

1. What I claim to be my invention is the CONDECAST EV2 THERMONUCLEAR PERFOMAGNETRON HYDROGEN BASED FUSION REACTOR and its components used to propel electric vehicles and expanding to other fields of mechanisms.

2. What I claim as my invention is thermonuclear magnetic phenomena of simulating lightning and thunder in my mechanical device that combusts hydrogen-based fuel attaining 26,000 miles per gallon from hydrogen and 300-500 mpg for fossil fuels. This is the ultimate solution to fusion technology of the Department of Energy harnessing sea water into hydrogen, a source of infinite energy till the end of the world.

3. What I claim as my invention is the adoption of my thermonuclear perfumagnetron fusion reactor splitting the technology to make brand new electric vehicles and converting old stocks to electric vehicles. After selling the brand new technology, I retain the exclusive ownership authority to license it.
